(19) United States
(12) Patent Application Publication
(10) Pub. No.: US 2024/0231889 A1
(43) Pub. Date: Jul. 11, 2024

(54) INFORMATION PROCESSING DEVICE, INFORMATION PROCESSING SYSTEM, INFORMATION PROCESSING METHOD, AND STORAGE MEDIUM

(71) Applicant: LAKEEL, INC., Minato-ku, Tokyo (JP)

(72) Inventors: Yoshiaki KAWAKAMI, Tokyo (JP); Kohei KASORI, Tokyo (JP)

(73) Assignee: LAKEEL, INC., Minato-ku, Tokyo (JP)

(21) Appl. No.: 18/562,192

(22) PCT Filed: Feb. 27, 2022
(86) PCT No.: PCT/JP2022/008101

§ 371 Date: Nov. 17, 2023

(30) Foreign Application Priority Data
May 18, 2021 (JP) 2021-084216

(51) Int. Cl. G06F 9/48; G06F 3/04817

(52) U.S. Cl. CPC G06F 9/4843; G06F 3/04817

(57) ABSTRACT

A management server is configured to, in response to a request from a client terminal, return a response to the client terminal. The management server includes a continuous service control unit, and a supplemental service control unit. The continuous service control unit executes a service corresponding to the request and returns a result of the execution to the client terminal as a response. Upon being triggered by execution of the service by the continuous service control unit, the supplemental service control unit executes a supplemental service corresponding to the request and transmits a result of the execution to a transmission destination corresponding to the supplemental service regardless of return of a response.

### TECHNICAL FIELD

The present invention relates to an information processing device, an information processing system, an information processing method and a program.

### BACKGROUND ART

In recent years, various services have been provided to companies and individual users in the field of information processing. These services are provided in a form which uses coordination by so-called cloud service and API (Application Programming Interface), for example.

An example of technique related to provision of such a service is disclosed in PTL 1. With the technique disclosed in PTL 1, a system that provides a service is smoothly managed by monitoring the system that provides the service.

### CITATION LIST

### Patent Literature

[PTL 1]
Japanese Unexamined Patent Application Publication No. 2021-043855

### SUMMARY OF INVENTION

### Technical Problem

However, most of general techniques assume that a specific service is provided, and it is expected that there is still room for improvement from the viewpoint of easily providing a variety of services.

The problem of the present invention is to provide a variety of services related to information processing more easily.

### Solution to Problem

In order to achieve the object described above, an information processing system according to an aspect of the present invention comprising:
an information processing device that, in response to a request made by each of a plurality of users using a client terminal, returns a response to the client terminal as a request source, the information processing device comprising:
an identification unit configured to identify, based on user identification information included in the request, whether a supplemental service corresponding to the user using the client terminal as the request source is present;
a first process control unit configured to execute a service corresponding to the request, and return a result of the execution as the response to the client terminal as the request source; and
a second process control unit configured to, when the supplemental service is identified to be present by the identification unit, upon being triggered by execution of the service by the first process control unit, execute the supplemental service, and return a result of the execution to a transmission destination corresponding to the supplemental service regardless of return of the response.

### Advantageous Effects of Invention

According to the present invention, it is possible to provide a variety of services related to information processing more easily.

### BRIEF DESCRIPTION OF DRAWINGS

FIG. 1 is a schematic diagram showing the system configuration of an entire information processing system S according to the present invention.

FIG. 2 is a conceptual diagram showing the outline of the continuous service function and the supplemental service function which are implemented by the information processing system S.

FIG. 3 is a diagram illustrating the hardware configuration of an information processing apparatus 800 configuring each apparatus.

FIG. 4 is a block diagram showing the functional configuration of the administrator terminal 10.

FIG. 5 is a block diagram showing the functional configuration of the database server 20.

FIG. 6 is a schematic chart showing the database structure (table) of the continuous service database 221.

FIG. 7 is a schematic chart showing the database structure (table) of the supplemental service database 222.

FIG. 8 is a block diagram showing the functional configuration of the management server 30.

FIG. 9 is a block diagram showing the functional configuration of the client terminal 40.

FIG. 10 is a block diagram showing the functional configuration of the service providing server 50.

FIG. 11 is a flowchart showing the flow of a database setting process executed by the administrator terminal 10.

FIG. 12 is a flowchart showing the flow of a setting storage process executed by the database server 20.

FIG. 13 is a flowchart showing the flow of a service identification process executed by the management server 30.

FIG. 14 is a flowchart showing the flow of a continuous service control process executed by the management server 30.

FIG. 15 is a flowchart showing the flow of a flow execution process executed by the management server 30.

FIG. 16 is a flowchart showing the flow of a supplemental service control process executed by the management server 30.

FIG. 17 is a flowchart showing the flow of a client-side process executed by the client terminal 40.

FIG. 18 is a flowchart showing the flow of a server-side process executed by the service providing server 50.

FIG. 19 is a schematic view showing a setting screen example to select which service is set as a continuous service.

FIG. 20 is schematic views showing setting screen examples which are related to supplemental service, and for selecting an API which triggers execution of supplemental service, and selecting a service which is set as a supplemental service.

FIG. 21 is schematic views showing setting screen examples which are related to supplemental service, and for selecting an API which triggers execution of supplemental service, and selecting a service which is set as a supplemental service.

### DESCRIPTION OF EMBODIMENTS

Hereinafter, an embodiment of the present invention will be described with reference to the drawings.

### [Configuration]

### [System Configuration]

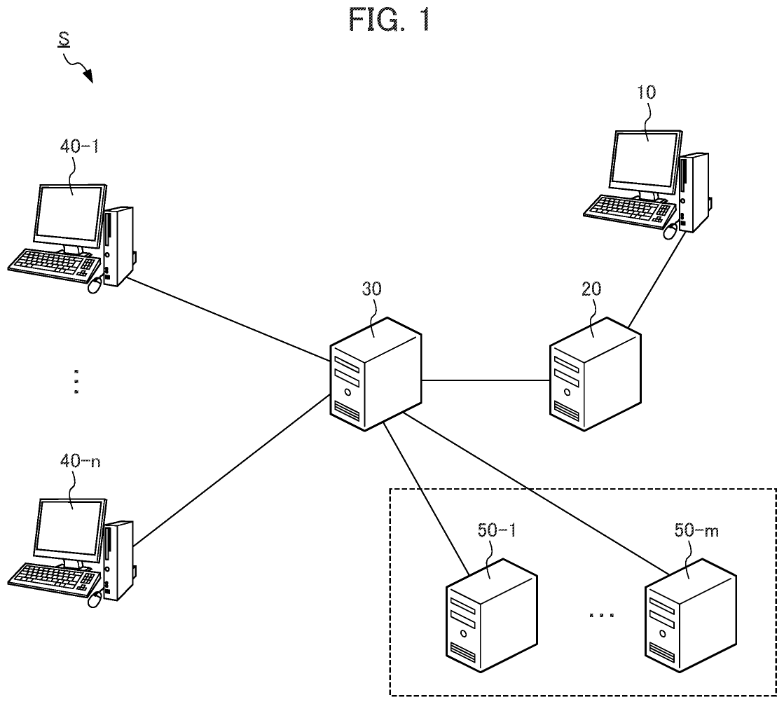

FIG. 1 is a schematic diagram showing the system configuration of an entire information processing system S according to the present invention.

As shown in FIG. 1, the information processing system S is constituted by including an administrator terminal 10, a database server 20, a management server 30, and client terminals 40-1 to 40-n (n is a natural number). In addition, the information processing system S is configured to coordinate with service providing servers 50-1 to 50-m (m is a natural number).

Furthermore, the administrator terminal 10 is communicatively connected to the database server 20. Similarly, the management server 30 is communicatively connected to each of the database server 20, the client terminals 40-1 to 40-n, and the service providing servers 50-1 to 50-m. These communication connections may be wired communication or wireless communication, and may be via a network, such as the Internet and a LAN (Local Area Network) which are not illustrated.

Note that in the following description, when the n client terminals 40 (here, the client terminals 40-1 to 40-n), and the m service providing servers 50 (here, the service providing servers 50-1 to 50-m) are described without being distinguished, they are simply referred to as “client terminal 40” and “service providing server 50” by omitting the end of each symbol.

The information processing system S is a system that provides various services to the clients who utilize the client terminal 40. For example, in the information processing system S, various services using coordination with API are provided in compliance with HTTP (Hyper Text Transfer Protocol).

The administrator terminal 10 is used by an administrator who administrates the information processing system S. In the administrator terminal 10, setting is performed for the management server 30 to provide various functions. For example, setting is performed for the management server 30 to provide the later-described continuous service function and supplemental service function.

The database server 20 stores, as a database, the settings made by the administrator terminal 10. The settings are made by the above-mentioned administrator terminal 10. The settings are retrieved, and utilized by the management server 30.

The management server 30 implements various functions (e.g., a continuous service function, and a supplemental service function) in the information processing system S based on the settings stored in the database server 20.

The client terminal 40 is used by a user (in other words, a client) who receives a service provided. The user may be a company or may be an individual. The client terminal 40 transmits a request to receive a service provided.

The service providing server 50 implements service provision by returning a response according to a request. The service providing server 50 may be a server constructed by an administrator who administrates the information processing system S, or may be an external server constructed by another business person different from the administrator.

### [Outline of Function]

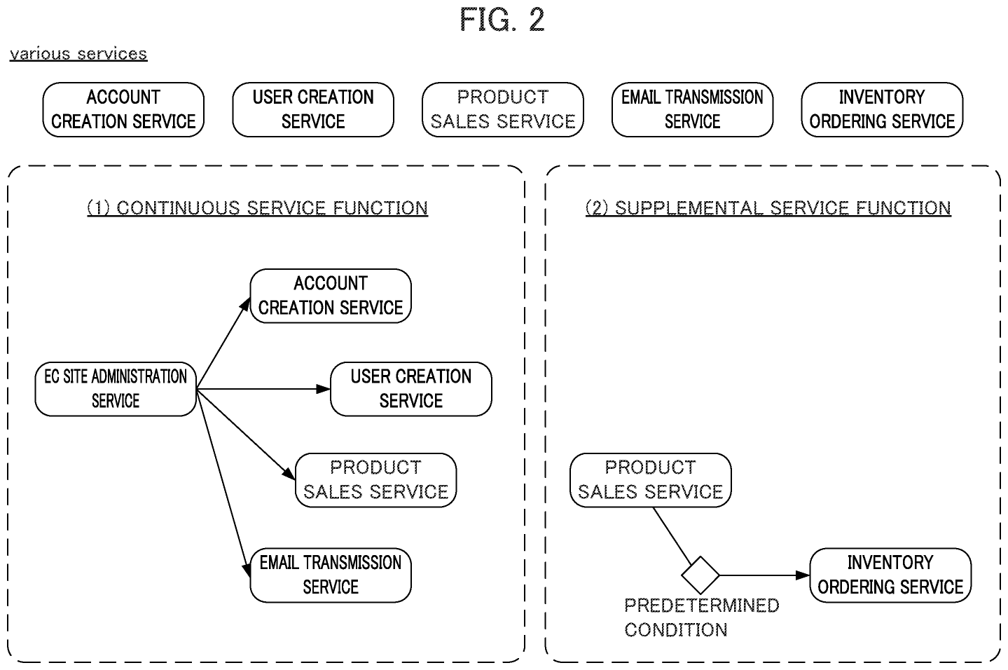

As mentioned above, the information processing system S having such a configuration implements, as characteristic functions, two functions: “(1) continuous service function” and “(2) supplemental service function”. These two functions will be described with reference to FIG. 2. FIG. 2 is a conceptual diagram showing the outline of the continuous service function and the supplemental service function which are implemented by the information processing system S.

Here, as a precondition of these functions, the client terminal 40 transmits a request to receive service provision. Meanwhile, the service providing server 50 implements service provision by returning a response for the request. In other words, the client terminal 40 and the service providing server 50 function as a so-called client server system.

However, in the information processing system S, communication between the client terminal 40 and the service providing server 50 are not performed directly, but performed via the management server 30. In other words, the service providing server 50 functions as a proxy (substitution) in the client server system. In this case, the management server 30 does not simply relay communication as a so-called proxy (substitution) server, but implements the functions, such as the above-mentioned continuous service function, and supplemental service function based on a predetermined setting.

These functions will be described using a specific example. For example, as shown in FIG. 2, it is assumed that the various services provided by each service providing server 50 include “account creation service”, “user creation service”, “product sales service”, “email transmission service”, and “inventory ordering service”. In such a situation, if the user of the client terminal 40 desires to receive multiple services, normally, multiple requests corresponding to the multiple services need to be made in a predetermined order. However, this results in a complicated process of the client terminal 40. Thus, the management server 30 implements the continuous service function and the supplemental service function by combining these multiple services as components.

When the continuous service function is implemented, the management server 30 executes multiple services corresponding to requests from the client terminal 40 as a continuous series of services (hereinafter referred to as a “continuous service”), and returns the execution result to the client terminal 40 as a response. The response corresponding to the request from the client terminal 40 may include the execution results of all services, or may include part of the service execution results, or may not include the execution result of any service. As to whether what type of response is returned may be defined in any way based on the content of service and the characteristics of service.

For example, let us assume that the user of the client terminal 40 is a business person who operates an EC (Electronic Commerce) site. In this case, multiple services, such as account creation service to create an account of a buyer, user creation service to register information on a buyer, product sales service to sell a product to be purchased, and email transmission service to notify a buyer via email that sales contract has been completed are set as one continuous service (here, “EC site administration service”) in advance. This setting is implemented, for example, by setting these multiple services as one continuous service in association with a request to the EC site administration service, the request including a client identification code that identifies the client.

When receiving, from the client terminal 40, a request including a client identification code to the EC site administration service, the management server 30 transmits requests to respective service providing servers 50 corresponding to the services in a sequential order based on the setting. Responses returned from respective service providing servers 50 in response to these requests are returned by the management server 30 to the client terminal 40 which is the request source. Consequently, the information processing system S can implement the continuous service function. In this case, as mentioned above, as to whether what type of response is returned may be defined in any way based on the content of service and the characteristics of service.

Meanwhile, when the supplemental service function is implemented, upon being triggered by execution of a certain service corresponding to a request from the client terminal 40, the management server 30 executes another service (hereinafter referred to as a “supplemental service”) corresponding to the certain service, and transmits the execution result to a transmission destination corresponding to the supplemental service regardless of return of a response.

For example, as in the example described above, it is assumed that the user of the client terminal 40 is a business person who operates an EC site. It is assumed that when a product is sold through the product sales service, the business person desires to add an “inventory ordering service” to order inventory of the product. In this case, after the product sales service is executed, pre-setting is performed so that the inventory ordering service is provided as a supplemental service. This setting is implemented, for example, by setting an inventory ordering service as a supplemental service in association with a request to the product sales service, the request including a client identification code that identifies the client.

When receiving a request to the product sales service from the client terminal 40, the request including the client identification code, the management server 30 transmits the request to a service providing server 50 corresponding to the product sales service based on the setting, and in response to the request, returns a response returned from the service providing server 50 to the client terminal 40 which is the request source. Meanwhile, the management server 30 transmits a request to a service providing server 50 corresponding to the inventory ordering service which is a supplemental service, and in response to the request, transmits a response returned from the service providing server 50 to a transmission destination (which may be the client terminal 40 as the request source) corresponding to the supplemental service. Consequently, the information processing system S can implement the supplemental service function.

Note that the continuous service function and the supplemental service function can be utilized by combining these. For example, the EC site administration service is executed by the continuous service function, and upon being triggered by execution of a product sales service included in the EC site administration service, the inventory ordering service can also be executed as a supplemental service. For example, the product sales service is executed in the supplemental service, and only when a predetermined condition (e.g., the number of inventories at the present time is less than a predetermined number) is satisfied, the inventory ordering service, which is a supplemental service, may be executed.

As described above, as the continuous service function, the management server 30 executes, as a continuous service, multiple services which are different for each request. In addition, as the supplemental service function, the management server 30 further executes a supplemental service separately from the continuous service, the supplemental service being different for each request. These executed continuous service and supplemental service are set according to a client who has made a request.

Thus, the management server 30 can provide an optimal service for the client utilizing the client terminal 40 based on a predetermined correspondence relationship only. In this case, the client terminal 40 only needs to transmit a request as usual. The service providing server 50 also only needs to return a response according to a request as usual. Thus, it is not necessary to perform work such as modification (e.g., edition of the source code) of existing software that provides continuous services and supplemental services, and a new service providing server 50 does not need to be constructed, thus multiple services can be provided by combining them as the components.

Therefore, the management server 30 enables to solve the problem of providing a variety of services related to information processing more easily.

In particular, it is not necessary to perform work such as modification (e.g., edition of the source code) of existing software that provides continuous services and supplemental services, thus the effort of the administrator and software developers of the information processing system S can be reduced. Accordingly, the following problem can be prevented: if software is modified, in connection to this, software for other services also needs to be modified. In addition, a service provided by another business person, for which modification of the source code is not practical in the first place, can be combined as a component. In other words, services can be further utilized.

Only changing the setting related to the correspondence relationships enables individual combinations of services and individual addition of a service to be implemented for each client who utilizes the client terminal 40 (in other words, individual customization). Therefore, advantage can be provided to the user of each client terminal 40 in addition to the administrator and software developers of the information processing system S.

### [Hardware Configuration]

The hardware configuration of each apparatus in the information processing system S will be described.

Each of the devices included in the information processing system S and the service providing server 50 that cooperates with the information processing system S is composed of an information processing apparatus 800 such as a smartphone, a tablet terminal, a personal computer, or a server device, and their basic configuration is the same.

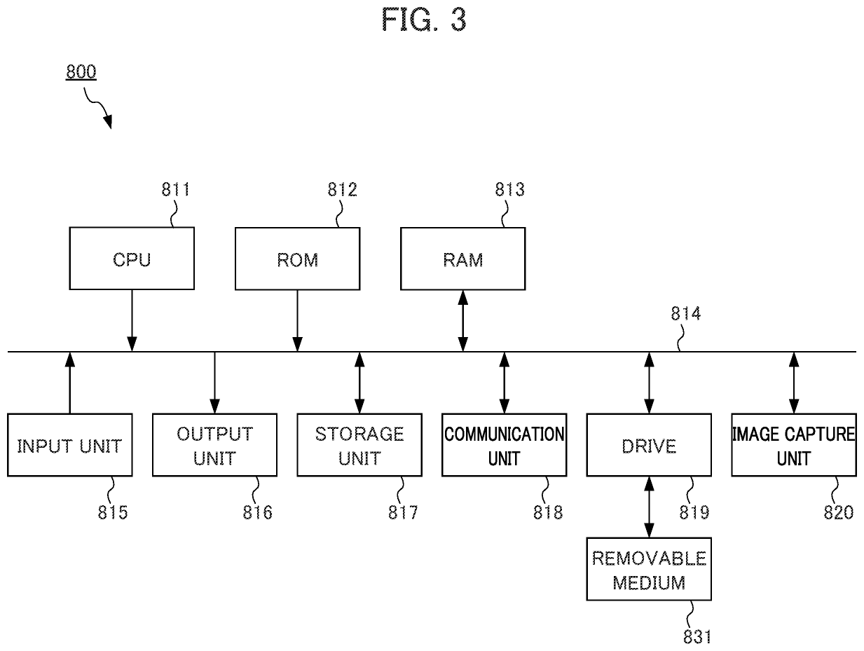

FIG. 3 is a diagram illustrating the hardware configuration of an information processing apparatus 800 configuring each apparatus.

As illustrated in FIG. 3, the information processing apparatus 800 configuring each apparatus includes a CPU (Central Processing Unit) 811, a ROM (Read Only Memory) 812, a RAM (Random Access Memory) 813, a bus 814, an input unit 815, an output unit 816, a storage unit 817, a communication unit 818, a drive 819, and an image capture unit 820.

The CPU 811 executes various processing according to programs that are recorded in the ROM 812, or programs that are loaded from the storage unit 820 to the RAM 813.

The RAM 813 also stores data and the like necessary for the CPU 811 to execute the various processing, as appropriate.

The CPU 811, the ROM 812 and the RAM 813 are connected to one another via the bus 814. The input unit 815, the output unit 816, the storage unit 817, the communication unit 818, the drive 819 and the image capture unit 820 are connected to the bus 814.

The input unit 815 is configured by various buttons and the like, and inputs a variety of information in accordance with instruction operations by the user.

The output unit 816 is configured by the display unit, a speaker, and the like, and outputs images and sound.

The storage unit 817 is configured by DRAM (Dynamic Random Access Memory) or the like, and stores various data managed by each server.

The communication unit 818 controls communication with other devices via networks.

A removable medium 831 composed of a magnetic disk, an optical disk, a magneto-optical disk, semiconductor memory or the like is installed in the drive 819, as appropriate. Programs that are read via the drive 819 from the removable medium 831 are installed in the storage unit 817, as necessary.

The image capture unit 820, which is configured by using an imaging apparatus including a lens and an image sensor, captures digital images of subjects.

When the information processing apparatus 800 is configured as the database server 20, the management server 30, or the service providing server 50, the image capture unit 820 may be omitted. When the information processing apparatus 800 is configured by using a tablet terminal, the input unit 815 may be configured by using a touch sensor which overlies the display of the output unit 816. Thus, the information processing apparatus 800 may have a configuration including a touch panel.

### [Functional Configuration]

Next, the functional configuration of each device in the information processing system S will be described.

### [Configuration of Administrator Terminal 10]

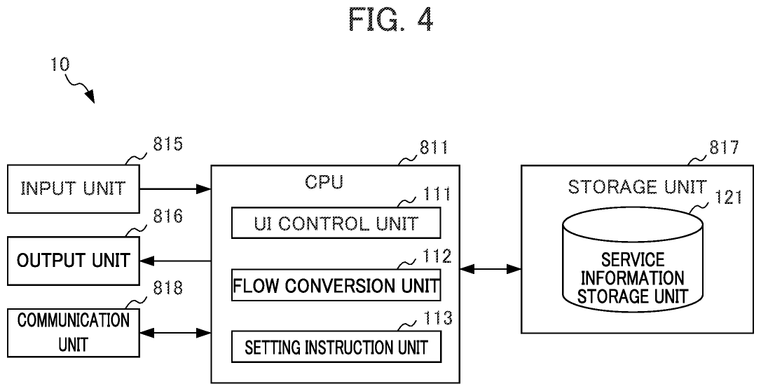

FIG. 4 is a block diagram showing the functional configuration of the administrator terminal 10.

As shown in FIG. 4, an UI control unit 111, a flow conversion unit 112, and a setting instruction unit 113 function in CPU 811 of the administrator terminal 10. A service information storage unit 121 is formed in a storage unit 817 of the administrator terminal 10. In also a case not specifically mentioned below, data necessary to implement a process is transmitted and received between these functional blocks at an appropriate timing as needed.

The UI control unit 111 controls the display of a user interface to implement the operation by the administrator. For example, the UI control unit 111 controls the display of a setting screen for the administrator to perform setting related to normal service, continuous service, and supplemental service. The setting screen may have any layout, and may serve as a graphical user interface to select which normal service, which continuous service, or which supplemental service corresponds to which request of which client, for example. Thus, the UI control unit 111 can perform setting related to normal service, continuous service, and supplemental service by only allowing the administrator to perform an easy operation of selecting a service. A specific example of such a graphical user interface will be described after the function and the operation of the entire information processing system S are described.

The flow conversion unit 112 converts result of selection of a continuous service, or a supplemental service into a computer-executable data format, the selection being made by the administrator who has referenced the graphical user interface. The computer-executable data format is data such that, for example, information necessary for execution of a continuous service and a supplemental service, and a source code to implement a predetermined function are written as a flow of block units in JSON (Java Script Object Notation) format.

Also, when setting (e.g., addition of a new normal service) related to normal service other than continuous service and supplemental service is made by the administrator, the flow conversion unit 112 converts the setting into a computer-executable data format. In this case, the computer-executable data format is data such that, for example, URL corresponding to the service providing server 50 that provides a service, the ID of a service, and the ID of API are written.

Note that information on service (e.g., information on the name and function of service, information on the service providing server 50 corresponding to a service, the ID of a service to create a request, the ID of API, information on the user of each client terminal 40, and information necessary for execution of other services), necessary to perform control of display by the UI control unit 111 and conversion by the flow conversion unit 112 is stored in the service information storage unit 121. In other words, the service information storage unit 121 serves as a storage unit (repository) that stores information related to service.

The setting instruction unit 113 performs setting related to normal service, continuous service, and supplemental service by storing the data after converted by the flow conversion unit 112 into the database server 20. For this purpose, the setting instruction unit 113 transmits the data after converted by the flow conversion unit 112 along with setting instructions to the database server 20.

### [Configuration of Database Server 20]

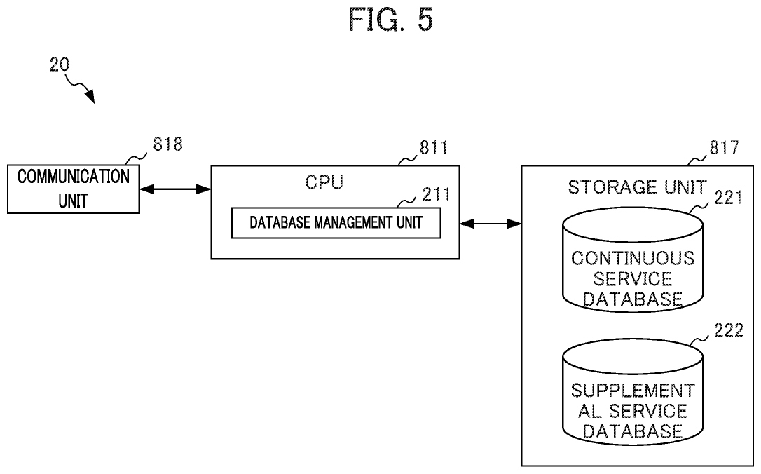

FIG. 5 is a block diagram showing the functional configuration of the database server 20.

As shown in FIG. 5, database management unit 211 functions in the CPU 811 of the database server 20. A continuous service database 221, and a supplemental service database 222 are formed in the storage unit 817 of the database server 20.

In also a case not specifically mentioned below, data necessary to implement s transmitted and received between these functional blocks at an appropriate timing as needed.

The database management unit 211 manages the databases constructed in the continuous service database 221, and the supplemental service database 222. Specifically, the database management unit 211 stores post-conversion data corresponding to the setting of normal service or continuous service into the database constructed in the continuous service database 221 based on the setting instructions transmitted from the setting instruction unit 113 of the administrator terminal 10, thereby updating the database. Similarly, the database management unit 211 stores post-conversion data corresponding to the setting of supplemental service into the database constructed in the supplemental service database 222 based on the setting instructions transmitted from the setting instruction unit 113 of the administrator terminal 10, thereby updating the database. In other words, the continuous service database 221 serves as a database (repository) that stores settings related to normal service, and settings related to the continuous service function. The supplemental service database 222 serves as a database (repository) that stores settings related to the supplemental service function.

When receiving a search request from the management server 30, the continuous service database 221 searches the continuous service database 221 or the supplemental service database 222 to extract information based on the search request, and returns the extracted information to the management server 30.

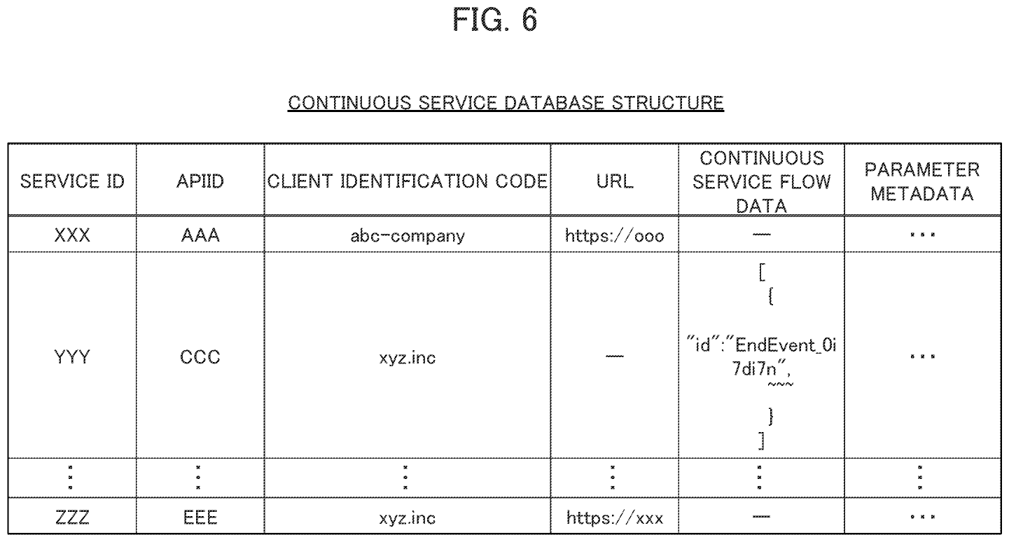

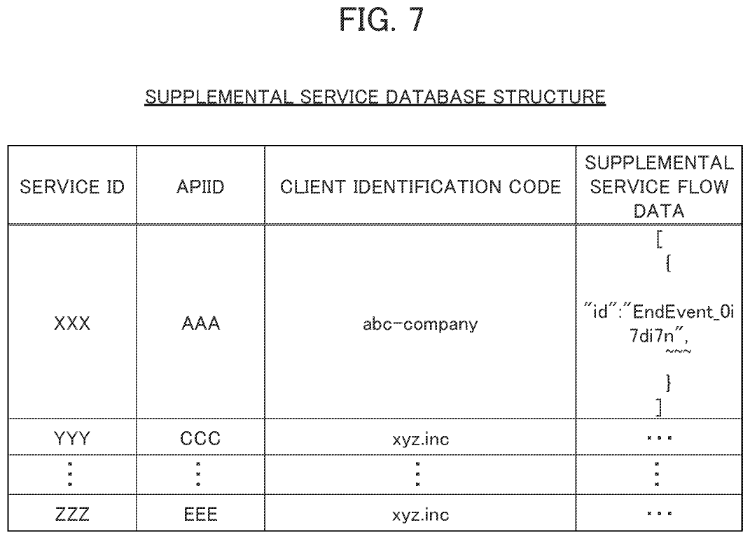

Next, the database structures (tables) of the continuous service database 221 and the supplemental service database 222 will be described with reference to FIG. 6 and FIG. 7.

FIG. 6 is a schematic chart showing the database structure (table) of the continuous service database 221. As shown in FIG. 6, the database structure (table) of the continuous service database 221 includes, as the columns (columns), “service ID”, “APIID”, “client identification code”, “URL”, “continuous service flow data”, and “parameter metadata”. In addition, the database structure (table) of the continuous service database 221 is provided with a row (record) for each of normal service and continuous service. Then, corresponding data is stored in each input item (field) by the database management unit 211.

Here, the service ID is an identifier to identify a normal service, a continuous service, or a supplemental service.

The APIID is an identifier to identify an API. In general, one service is coordinated with multiple APIs, and implemented by making multiple requests. Thus, in order to implement multiple requests corresponding to the one service, a service ID corresponding to the one service and multiple APIIDs corresponding to the multiple requests are combined to be utilized. Consequently, multiple requests corresponding to the one service can be implemented.

The client identification code is an identifier to identify the client who is the user of the client terminal 40. For example, when the user of the client terminal 40 is a company, the company name is utilized as the client identification code.

URL is a URL corresponding to the service providing server 50 that provides a service. For a normal service, the URL is stored. Meanwhile, for a continuous service, the URL is not stored.

The continuous service flow data is data after being converted by the flow conversion unit 112 of the administrator terminal 10, and written as a flow of block units in JSON format. For a continuous service, the continuous service flow data is stored. Meanwhile, for a normal service, the continuous service flow data is not stored.

Parameter metadata is information that, upon provision of a service using coordination with API, is related to the parameter required by the API. For example, in the case of an API that provides user information, a parameter called “userId” to identify which user's information is to be provided must be transmitted, and data obtained by collecting such information required by the API is the parameter metadata. A request is created based on the parameter metadata.

FIG. 7 is a schematic chart showing the database structure (table) of the supplemental service database 222. As shown in FIG. 7, the database structure (table) of the supplemental service database 222 includes, as the columns (columns), “service ID”, “APIID”, “client identification code”, and “supplemental service flow data”. In addition, the database structure (table) of the supplemental service database 222 is provided with a row (record) for each of supplemental services. Then, corresponding data is stored in each input item (field) by the database management unit 211.

Here, the service ID is an identifier to identify a supplemental service.

The APIID is an identifier to identify an API.

The client identification code is an identifier to identify the client who is the user of the client terminal 40.

The supplemental service flow data is data after being converted by the flow conversion unit 112 of the administrator terminal 10, and written as a flow of block units in JSON format. In the supplemental service database 222, these four pieces of information are associated with each other.

### [Configuration of Management Server 30]

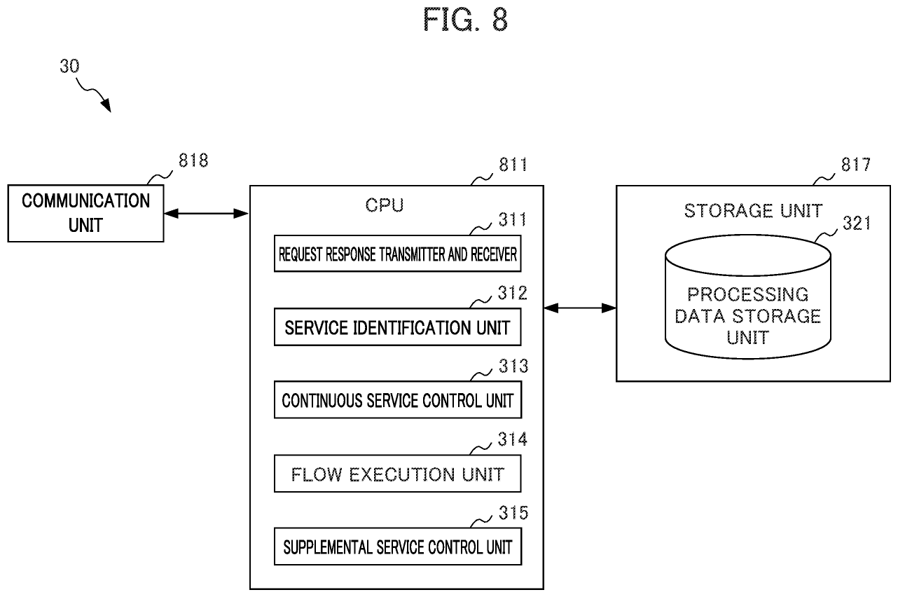

FIG. 8 is a block diagram showing the functional configuration of the management server 30.

As shown in FIG. 8, a request response transmitter and receiver 311, a service identification unit 312, a continuous service control unit 313, a flow execution unit 314, and a supplemental service control unit 315 function in the CPU 811 of the management server 30. A processing data storage unit 321 is formed in the storage unit 817 of the management server 30.

In also a case not specifically mentioned below, data necessary to implement a process is transmitted and received between these functional blocks at an appropriate timing as needed.

The request response transmitter and receiver 311 transmits and receives a request and a response. Specifically, the request response transmitter and receiver 311 receives a request from the client terminal 40. In response to the request, the request response transmitter and receiver 311 transmits a request created in the management server 30 to a service providing server 50 corresponding to the request. Furthermore, the request response transmitter and receiver 311 receives a response returned from the service providing server 50, and transmits (in other words, returns) the response to the corresponding client terminal 40, and to a transmission destination corresponding to a supplemental service.

Here, in order to implement the continuous service function and the supplemental service function, the service identification unit 312, the continuous service control unit 313, the flow execution unit 314, and the supplemental service control unit 315 execute respective predetermined functions. When these functions are executed, arguments and return values which occur between these functional blocks are temporarily stored in the processing data storage unit 321. A request and a response transmitted and received by the request response transmitter and receiver 311 are also temporarily stored in the processing data storage unit 321. In other words, the processing data storage unit 321 serves as a storage unit (repository) that stores information related to various processes executed in the management server 30.

The service identification unit 312 executes a function to identify a normal service or a continuous service corresponding to the request based on the request received from the client terminal 40, and the information stored in the continuous service database 221 of the database server 20.

The continuous service control unit 313 performs control to execute a normal service corresponding to the request, and control to cause the flow execution unit 314 to execute a corresponding continuous service. The continuous service control unit 313 returns an execution result of a normal service or a continuous service to the client terminal 40 as a response via the request response transmitter and receiver 311. In this case, as mentioned above, as to whether what type of response is returned may be defined in any way based on the content of service and the characteristics of service.

The flow execution unit 314 executes a continuous service and a supplemental service based on the control of the continuous service control unit 313 and the supplemental service control unit 315. These services are executed based on the continuous service flow stored in the continuous service database 221 of the database server 20, and the supplemental service flow stored in the supplemental service database 222 of the database server 20.

Upon being triggered by the execution of a supplemental service or a continuous service by the continuous service control unit 313, the supplemental service control unit 315 performs control to cause the flow execution unit 314 to execute a supplemental service corresponding to the request. The supplemental service control unit 315 transmits the execution result of the supplemental service to a transmission destination corresponding to the supplemental service regardless of return of a response for a normal service or a continuous service.

### [Configuration of Client Terminal 40]

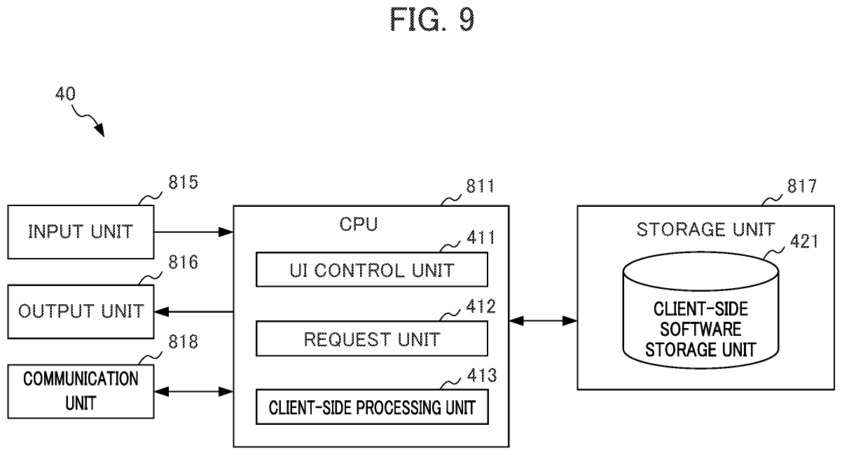

FIG. 9 is a block diagram showing the functional configuration of the client terminal 40.

As shown in FIG. 9, a UI control unit 411, a request unit 412, and a client-side processing unit 413 function in the CPU 811 of the client terminal 40. A client-side software storage unit 421 is formed in the storage unit 817 of the client terminal 40.

In also a case not specifically mentioned below, data necessary to implement a process is transmitted and received between these functional blocks at an appropriate timing as needed.

The UI control unit 411 controls the display of a user interface to implement an operation of the user of the client terminal 40. For example, the UI control unit 411 controls the display of an instruction screen for a user to issue execution instructions for a normal service, a continuous service, or a supplemental service, and the display of a browse screen for browsing information (e.g., a character, a still image, and a moving image) provided by these services.

When execution instructions of a user are issued or when a predetermined condition (e.g., arrival of a predetermined cycle) is satisfied, the request unit 412 creates a request to execute a normal service, a continuous service, or a supplemental service. The request unit 412 then transmits the created request to the management server 30. The request includes the service ID and the APIID of the service to be executed, and a client identification code (hereinafter referred to as an “identification information group”) corresponding to the user of the client terminal 40.

The request further includes a request parameter. The request parameter is a parameter that, upon provision of a service using coordination with API, is to be actually transmitted to the service providing server 50 corresponding to the API. For example, as illustrated in the description of the continuous service database 221 of the database server 20, when the parameter metadata is an API that provides user information, the request parameter is like “userId: Xxxxxx-Yyyyyy”, obtained by applying a parameter corresponding to the actual value. Note that the “Xxxxxx-Yyyyyy” is an alphabetical expression of the surname and the first name of a user.

The client-side processing unit 413 causes client-side software (e.g., a client-side program corresponding to the service) for receiving provision of the service to be executed corresponding to the service to be provided. The operation of client-side software by the client-side processing unit 413 implements the display of various screens generated by the UI control unit 411, and the creation of a request by the request unit 412. The client-side software operated by the client-side processing unit 413 is stored in the client-side software storage unit 421. In other words, the client-side software storage unit 421 serves as a storage unit (repository) that stores the client-side software.

### [Configuration of Service Providing Server 50]

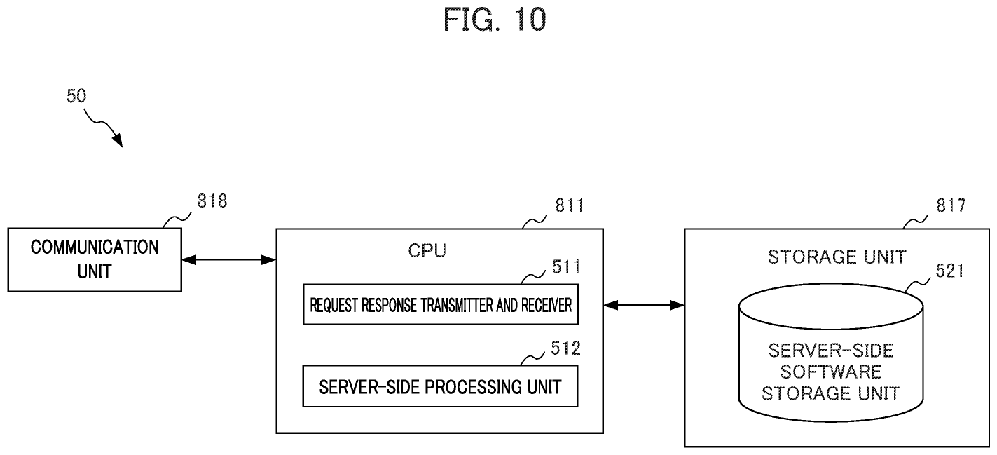

FIG. 10 is a block diagram showing the functional configuration of the service providing server 50.

As shown in FIG. 10, a request response transmitter and receiver 511, and a server-side processing unit 512 function in the CPU 811 of the service providing server 50. A server-side software storage unit 521 is formed in the storage unit 817 of the service providing server 50. In also a case not specifically mentioned below, data necessary to implement a process is transmitted and received between these functional blocks at an appropriate timing as needed.

The request response transmitter and receiver 511 transmits and receives a request and a response. Specifically, the request response transmitter and receiver 511 receives a request from the management server 30. In response to the request, the request response transmitter and receiver 511 also returns a response created in the server-side processing unit 512 to the management server 30.

The server-side processing unit 512 causes server-side software (e.g., a server-side program corresponding to the service) for receiving provision of the service to be executed corresponding to the service to be provided. The operation of server-side software by the server-side processing unit 512 creates a response. The server-side processing unit 512 then transmits (in other words, returns) the created response to the management server 30 via the request response transmitter and receiver 511. The server-side software is stored in the server-side software storage unit 521. In other words, the server-side software storage unit 521 serves as a storage unit (repository) that stores the server-side software.

### [Operation]

Next, the operation of the information processing system S will be described.

### [Database Setting Process]

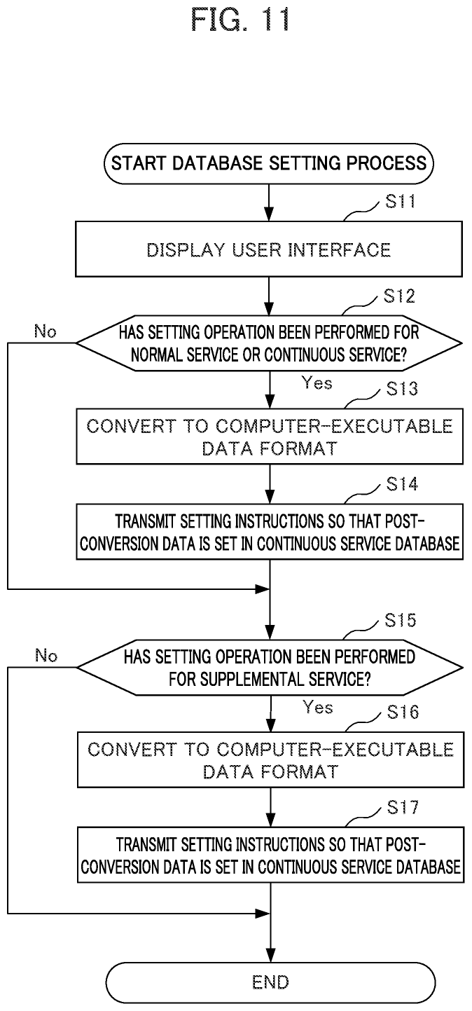

FIG. 11 is a flowchart showing the flow of a database setting process executed by the administrator terminal 10.

The database setting process is started with activation of the administrator terminal 10, and repeatedly executed.

When the database setting process is started, in step S11, the UI control unit 111 displays a user interface (here, a graphical user interface).

In step S12, the flow conversion unit 112 determines whether a setting operation for a normal service or a continuous service has been received, the setting operation being made by the administrator who has referenced the graphical user interface. When a setting operation has been received, in step S12, determination of Yes is made, and the process proceeds to step S13. Meanwhile, when a setting operation has not been received, in step S13, determination of No is made, and the process proceeds to step S15.

In step S13, the flow conversion unit 112 converts result of selection of a normal service, or a continuous service into a computer-executable data format, the selection being made by the administrator who has referenced the graphical user interface.

In step S14, the setting instruction unit 113 transmits the data after converted by the flow conversion unit 112 and the setting instructions to the database server 20 in order to store the data service database 222 of the after conversion in the supplemental database server 20.

In step S15, the flow conversion unit 112 determines whether a setting operation for a supplemental service by the administrator who has referenced the graphical user interface has been received. When a setting operation has been received, in step S15, determination of Yes is made, and the process proceeds to step S16. Meanwhile, when a setting operation has not been received, in step S15, determination of No is made, and the present process is completed. The process is then repeated from step S11.

In step S16, the flow conversion unit 112 converts result of selection of a supplemental service into a computer-executable data format, the selection being made by the administrator who has referenced the graphical user interface.

In step S17, the setting instruction unit 113 transmits the data after converted by the flow conversion unit 112 and the setting instructions to the database server 20 in order to store the data after conversion in the supplemental service database 222 of the database server 20. Thus, the present process is completed. The process is then repeated from step S11.

### [Setting Storage Process]

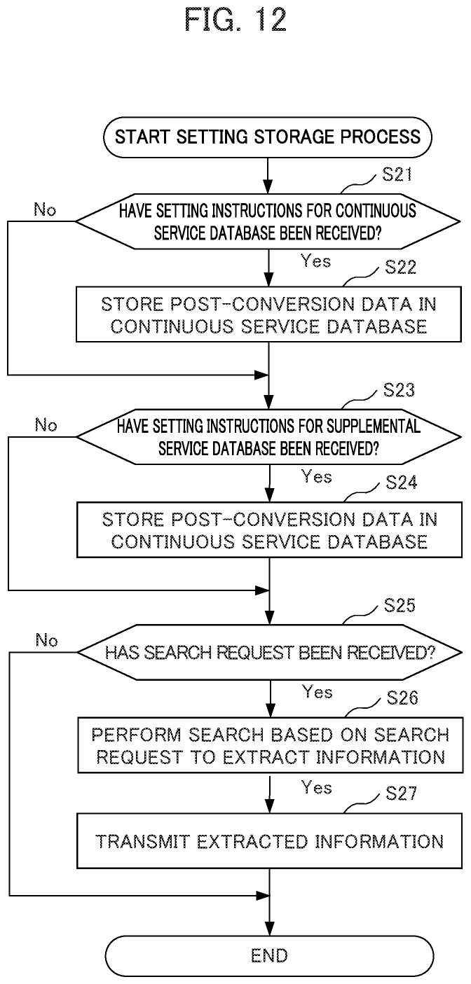

FIG. 12 is a flowchart showing the flow of a setting storage process executed by the database server 20.

The setting storage process is started with activation of the database server 20, and repeatedly executed.

When the setting storage process is started, in step S21, the database management unit 211 determines whether setting instructions for the continuous service database 221 has been received from the administrator terminal 10. When setting instructions have been received, in step S21, determination of Yes is made, and the process proceeds to step S22. Meanwhile, in a case, in step S21, determination of No is made, and the process proceeds to step S23.

In step S22, the database management unit 211 stores post-conversion data corresponding to the setting of normal service or continuous service into the continuous database constructed in the continuous service database 221 based on the setting instructions transmitted from the setting instruction unit 113 of the administrator terminal 10, thereby updating the continuous database.

In step S23, the database management unit 211 determines whether setting instructions for the supplemental service database 222 have been received from the administrator terminal 10. When setting instructions have been received, in step S23, determination of Yes is made, and the process proceeds to step S24. Meanwhile, in a case, in step S21, determination of No is made, and the process proceeds to step S25.

In step S24, the database management unit 211 stores post-conversion data corresponding to the setting of supplemental service into the supplemental database constructed in the supplemental service database 222 based on the setting instructions transmitted from the setting instruction unit 113 of the administrator terminal 10, thereby updating the supplemental database.

In step S25, the database management unit 211 determines whether a search request has been received from the management server 30. When a search request has been received, in step S25, determination of Yes is made, and the process proceeds to step S26. Meanwhile, when a search request has not been received, in step S25, determination of No is made, and the present process is completed. The process is then repeated from step S21.

In step S26, the database management unit 211 searches the continuous service database 221 or the supplemental service database 222 to extract information based on the search request.

In step S27, the database management unit 211 transmits (in other words, returns) the extracted information to the management server 30. Thus, the present process is completed. The process is then repeated from step S11.

### [Service Identification Process]

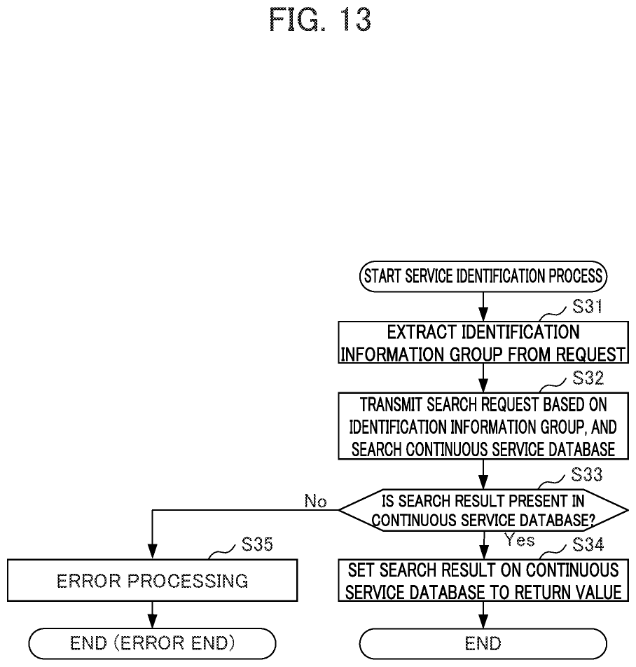

FIG. 13 is a flowchart showing the flow of a service identification process executed by the management server 30.

The service identification process is executed when the management server 30 receives a request from the client terminal 40.

When the service identification process is started, in step S31, the service identification unit 312 extracts an identification information group (specifically, the service ID and the APIID of a service to be executed, and the client identification code corresponding to the user of the client terminal 40) from the received request. These are the arguments of the present process.

In step S32, the service identification unit 312 transmits a search request with search conditions of the identification information group to the database server 20 to search the continuous service database constructed in the continuous service database 221.

In step S33, the service identification unit 312 determines whether a search result corresponding to the search conditions is present in the continuous service database. When a search result is present, in step S33, determination of Yes is made, and the process proceeds to step S34. Meanwhile, when a search result is not present, in step S33, determination of No is made, and the process proceeds to step S35.

In step S34, the service identification unit 312 sets the search results (in other words, information extracted based on the search conditions) on the continuous service database to the return value of the present process, and temporarily stores the return value in the processing data storage unit 321. Thus, the present process is completed.

In step S35, the service identification unit 312 performs error processing. As the error processing, for example, an error message, such as a message indicating that an impractical service has been requested, is transmitted to the client terminal 40. Thus, the present process is completed.

### [Continuous Service Control Process]

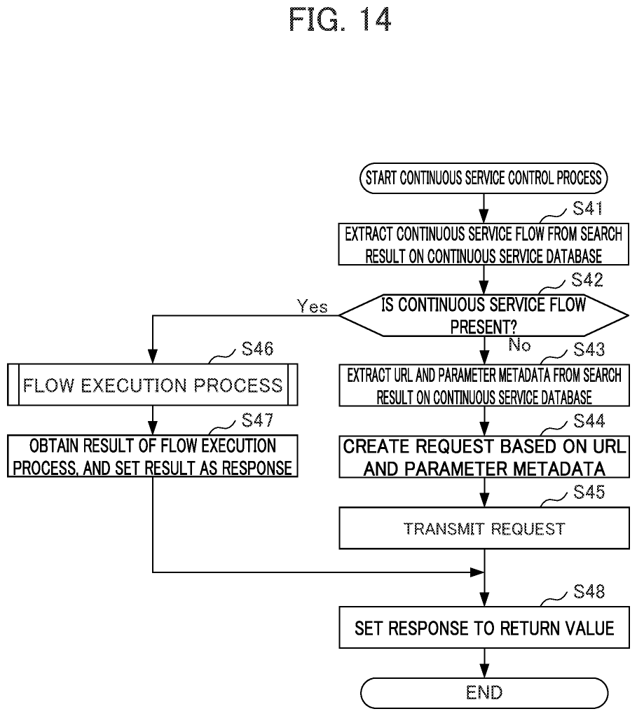

FIG. 14 is a flowchart showing the flow of a continuous service control process executed by the management server 30.

When the above-described service identification process is completed normally, the continuous service control process is executed subsequently.

When the service identification process is started, in step S41, the continuous service control unit 313 extracts a continuous service flow from the search results on the continuous service database, which are the return values of the service identification process. The search results on the continuous service database, and the request parameter included in the request received from the client terminal 40 are the arguments of the present process.

In step S42, the continuous service control unit 313 determines whether a continuous service flow is present (in other words, whether the service to be executed is a continuous service). When a continuous service flow is present, in step S42, determination of Yes is made, and the process proceeds to step S46. Meanwhile, when a continuous service flow is not present, in step S42, determination of No is made, and the process proceeds to step S43.

In step S43, the continuous service control unit 313 extracts URL and parameter metadata from the search results on the continuous service database.

In step S44, the continuous service control unit 313 creates a request based on the URL and the parameter metadata. Specifically, the continuous service control unit 313 extracts information corresponding to the parameter metadata from the request parameter which is an argument, and creates a request to the service providing server 50 corresponding to the URL.

In step S45, the continuous service control unit 313 transmits the created request to the service providing server 50 corresponding to the URL. Thus, a request for a normal service has been made.

In step S46, the continuous service control unit 313 sets a target process of a continuous service flow, and causes the flow execution unit 314 to execute the later-described flow execution process.

In step S47, the continuous service control unit 313 obtains the result of the flow execution process executed by the flow execution unit 314, and sets the result as the response.

In step S48, the continuous service control unit 313 sets the response (the response returned from the service providing server 50 in response to the request in step S45, or the response based on the result of the flow execution process obtained in step S47) to the return value of the present process, and temporarily stores the return value in the processing data storage unit 321. Thus, the present process is completed.

### [Flow Execution Process]

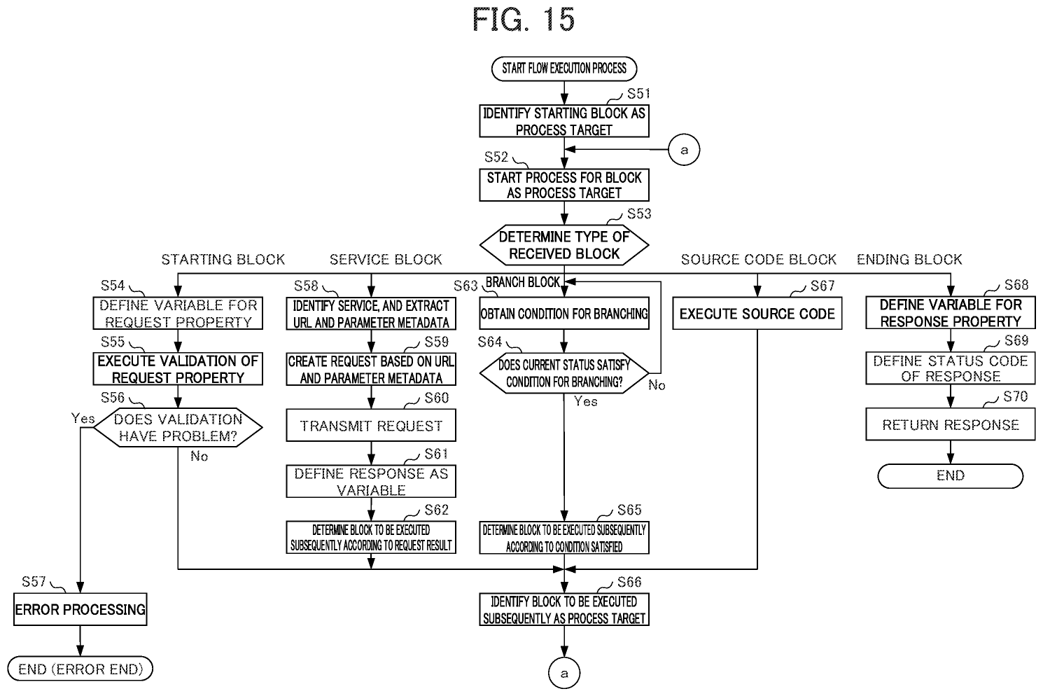

FIG. 15 is a flowchart showing the flow of a flow execution process executed by the management server 30.

The flow execution process is executed as the above-described service identification process, and as a subroutine in the later-described supplemental service control process.

When the flow execution process is started, in step S51, the flow execution unit 314 identifies, as the process target, the data in the starting block of a continuous service flow as an execution target or a supplemental service flow as an execution target. The continuous service flow as an execution target or the supplemental service flow as an execution target are the arguments of the present process.

In step S52, the flow execution unit 314 starts the process corresponding to the block as an execution target.

In step S53, the flow execution unit 314 determines the type of the received block. As the type of block, for example, “starting block” “service block” “branch block” “source code block” and “ending block” are defined.

When the block received in step S53 is a starting block, the process proceeds to step S54.

When the block received in step S53 is a service block, the process proceeds to step S58.

When the block received in step S53 is a branch block, the process proceeds to step S63.

When the block received in step S53 is a source code block, the process proceeds to step S68.

When the block received in step S53 is an ending block, the process proceeds to step S69.

In step S54, the flow execution unit 314 defines a variable for request property related to the request received from the client terminal 40.

In step S55, the flow execution unit 314 executes validation (verification) of the request property.

In step S56, the flow execution unit 314 determines whether the validation has a problem. When the validation has a problem, in step S56, determination of Yes is made, and the process proceeds to step S57. Meanwhile, when the validation has no problem, in step S56, determination of No is made, and the process proceeds to step S66.

In step S57, the flow execution unit 314 performs error processing. As the error processing, for example, an error message, such as a message indicating that an impractical service has been requested, may be transmitted to the client terminal 40. Thus, the present process is completed.

In step S58, the flow execution unit 314 identifies the continuous service as an execution target or the supplemental service as an execution target based on the data in the received block, and extracts the URL and the parameter metadata of the continuous service or the supplemental service.

In step S59, the flow execution unit 314 creates a request based on the URL and the parameter metadata. Specifically, the flow execution unit 314 extracts information corresponding to the parameter metadata from the request parameter which is an argument, and creates a request to the service providing server 50 corresponding to the URL.

In step S60, the flow execution unit 314 transmits the created request to the service providing server 50 corresponding to the URL. Thus, a request for a continuous service or a supplemental service has been made. Note that the processes in step S59 to step S60 are equivalent to the processes in step S43 to step S45 in the above-described continuous service control process, thus the continuous service control unit 313 may be called, and the processes may be executed by the continuous service control unit 313 instead of the flow execution unit 314.

In step S61, the flow execution unit 314 defines the response returned from the service providing server 50 in response to the request as a variable.

In step S62, the flow execution unit 314 determines the block to be executed subsequently according to the response. After step S62, the flow execution unit 314 proceeds to step S66.

In step S63, the flow execution unit 314 obtains a condition for branching from the branch block.

In step S64, the flow execution unit 314 determines whether the current status satisfies the obtained condition for branching.

When the current status does not satisfy the obtained condition for branching, in step S64, determination of No is made, and the process proceeds to step S63.

Meanwhile, when the current status satisfies the obtained condition for branching, in step S64, determination of Yes is made, and the process proceeds to step S65.

In step S65, the flow execution unit 314 determines the block to be executed subsequently according to the condition satisfied.

In step S66, the flow execution unit 314 identifies the block to be executed subsequently as process handling. After step S66, the process proceeds to step S52.

In step S67, the flow execution unit 314 executes the source code defined in the block. After step S67, the process proceeds to step S66.

In step S68, the flow execution unit 314 defines a variable for response property related to the request.

In step S69, the flow execution unit 314 defines the status code (here, HTTP response status code) of the response.

In step S70, the flow execution unit 314 returns a response to the original caller (specifically, the continuous service control unit 313 or the supplemental service control unit 315) of the present flow execution process, the response being an execution result of the present flow execution process. The response is transmitted to a transmission destination corresponding to the response by the continuous service control unit 313 or the supplemental service control unit 315 to which the response has been returned. Thus, the present process is completed.

### [Supplemental Service Control Process]

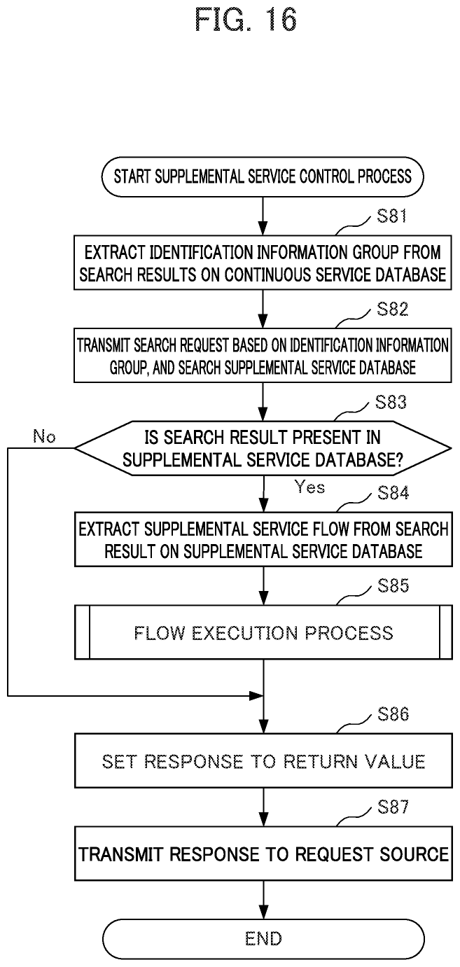

FIG. 16 is a flowchart showing the flow of a supplemental service control process executed by the management server 30.

When the above-described continuous service control process is completed, the supplemental service control process is executed subsequently.

When the supplemental service control process is started, in step S81, the supplemental service control unit 315 extracts an identification information group (specifically, the service ID and the APIID of a service to be executed, and the client identification code corresponding to the user of the client terminal 40) from the search results on the continuous service database, which are the return values of the service identification process. The identification information group and the response as the return value of the continuous service control process are the arguments of the present process.

In step S82, the supplemental service control unit 315 transmits a search request with search conditions of the identification information group to the database server 20 to search the supplemental service database constructed in the supplemental service database 222.

In step S83, the supplemental service control unit 315 determines whether a search result corresponding to the search conditions is present in the supplemental service database. When a search result is present, in step S83, determination of Yes is made, and the process proceeds to step S84. Meanwhile, when a search result is not present, in step S83, determination of No is made, and the process proceeds to step S86.

In step S84, the supplemental service control unit 315 extracts a supplemental service flow from the search results (in other words, information extracted based on the search conditions) on the supplemental service database.

In step S85, the supplemental service control unit 315 sets a target process of a supplemental service flow, and causes the flow execution unit 314 to execute the above-described flow execution process.

In step S86, the supplemental service control unit 315 sets the response as an argument to the return value of the present process.

In step S87, the supplemental service control unit 315 transmits (in other words, returns) the response set as the return value to the client terminal 40 as the request source via the request response transmitter and receiver 311. Thus, the present process is completed.

### [Client-Side Process]

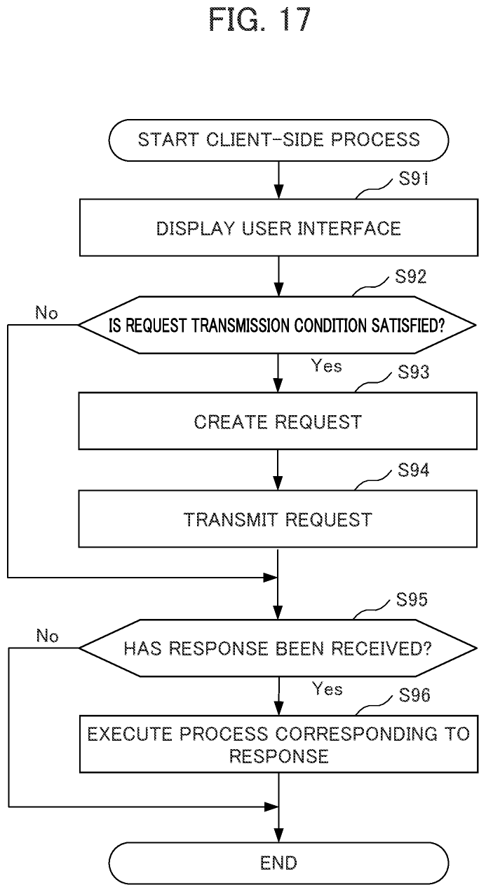

FIG. 17 is a flowchart showing the flow of a client-side process executed by the client terminal 40.

The client-side process is started with activation of the client terminal 40, and repeatedly executed.

When the client-side process is started, in step S91, the UI control unit 411 displays a user interface.

In step S92, the request unit 412 determines whether the transmission condition for the request is satisfied. For example, when execution instructions of a user are issued or when a predetermined condition (e.g., arrival of a predetermined cycle) is satisfied, the transmission condition for the request is determined to be satisfied. When the transmission condition for the request is satisfied, in step S92, determination of Yes is made, and the process proceeds to step S93. Meanwhile, when the transmission condition for the request is not satisfied, in step S92, determination of No is made, and the process proceeds to step S94.

In step S94, the request unit 412 creates a request. As described above, the request includes the identification information group (specifically, the service ID and the APIID of a service to be executed, and the client identification code corresponding to the user of the client terminal 40) and the request parameter.

In step S95, the request unit 412 transmits the created request to the management server 30.

In step S96, the client-side processing unit 413 determines whether a request has been received from the management server 30. When a request has been received, in step S95, determination of Yes is made, and the process proceeds to step S96. Meanwhile, when a request has not been received, in step S95, determination of No is made, and the present process is completed. The process is then repeated from step S91.

In step S96, the client-side processing unit 413 executes a process (e.g., display of the information obtained) corresponding to the response. Thus, the present process is completed. The process is then repeated from step S91.

### [Server-Side Process]

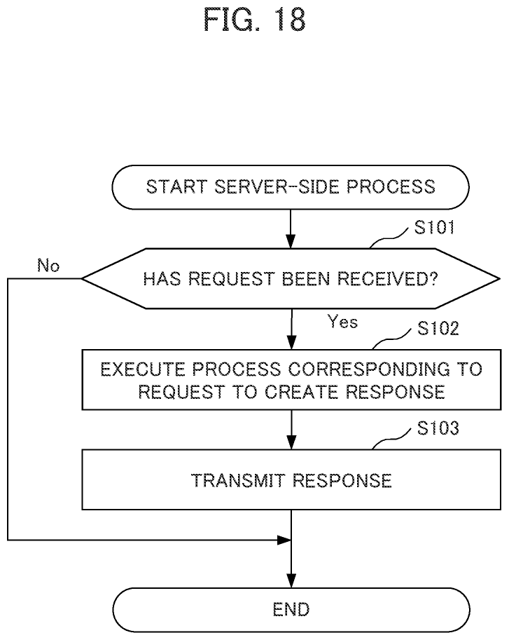

FIG. 18 is a flowchart showing the flow of a server-side process executed by the service providing server 50.

The server-side process is started with activation of the service providing server 50, and repeatedly executed.

When the server-side process is started, in step S101, the request response transmitter and receiver 511 determines whether a request has been received. When a request has been received, in step S101, determination of Yes is made, and the process proceeds to step S102. Meanwhile, in a case, in step S101, determination of No is made, and the present process is completed. The process is then repeated from step S101.

In step S102, the server-side processing unit 512 executes the process corresponding to the request to create a response.

In step S103, the server-side processing unit 512 transmits (in other words, returns) the response to the management server 30 via the request response transmitter and receiver 511.

The processes described above enable the management server 30 to provide an optimal service for the client utilizing the client terminal 40 based on a pre-set correspondence relationship only. In this case, the client terminal 40 only needs to transmit a request as usual. The service providing server 50 also only needs to return a response in response to a request as usual. Thus, it is not necessary to perform work such as modification (e.g., edition of the source code) of existing software that provides continuous services and supplemental services, and a new service providing server 50 does not need to be constructed, thus multiple services can be provided by combining them as the components.

Therefore, the processes described above enable to solve the problem of providing a variety of services related to information processing more easily.

### [Screen Display Example]

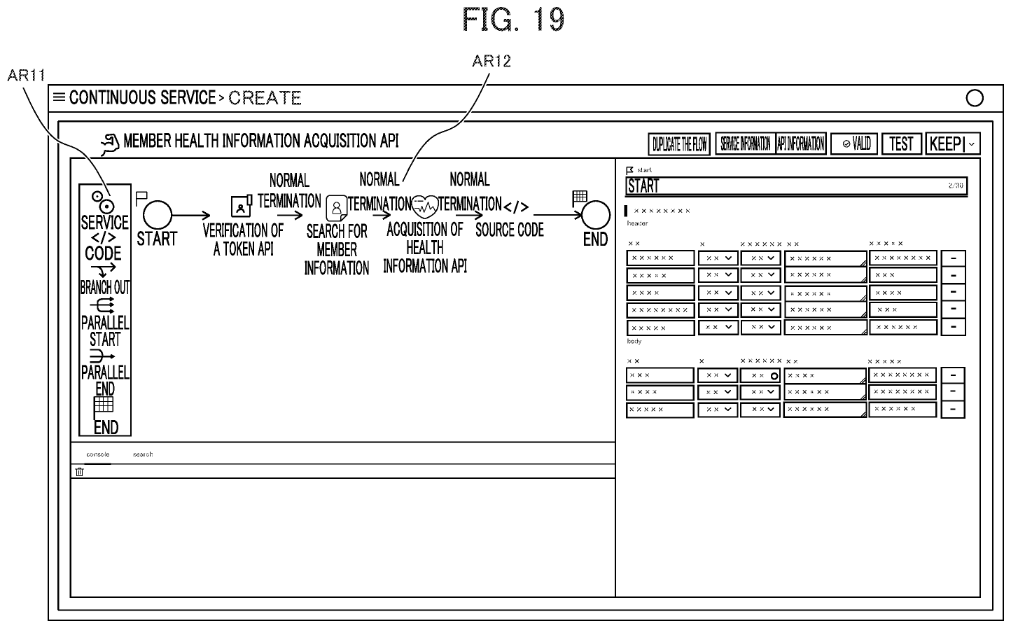

Display examples of setting screens for the administrator to perform setting related to normal service, continuous service, and supplemental service at the administrator terminal 10 will be described with reference to FIG. 19 to FIG. 21.

In these setting screen examples, the UI control unit 111 controls the display based on the information stored in the service information storage unit 121, thereby performing display on a display included in an output unit 816 of the administrator terminal 10. Specifically, in these setting screen examples, a graphical user interface to select which normal service, which continuous service, or which supplemental service corresponds to the request is displayed.

FIG. 19 is a schematic view showing a setting screen example to select which service is set as a continuous service. On display area AR11, icons to select a component included in a continuous service are displayed. For example, with the icons, a service can be selected, a source code can be selected, and a setting related to branching and parallel processing can be selected. A service or the like selected in the display area AR11 can be arranged in display area AR12 as a component included in a continuous service. The administrator can easily create a continuous service flow corresponding to the continuous service by performing an operation of moving these selected services with a mouse. In this example, a continuous service flow called “member health information acquisition” is created in which a series of services, such as verification of a token, search for member information, acquisition of health information, and execution of a process based on source code are executed.

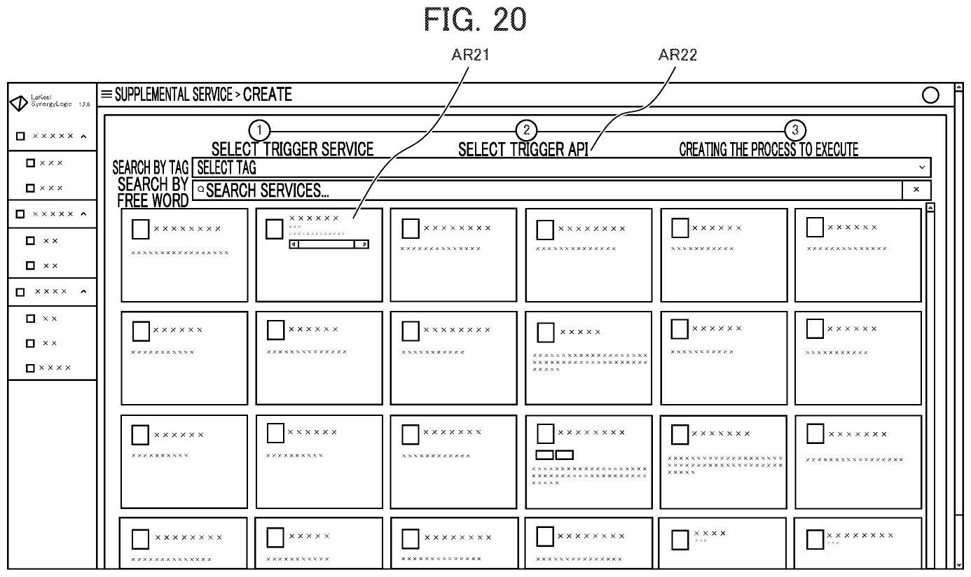

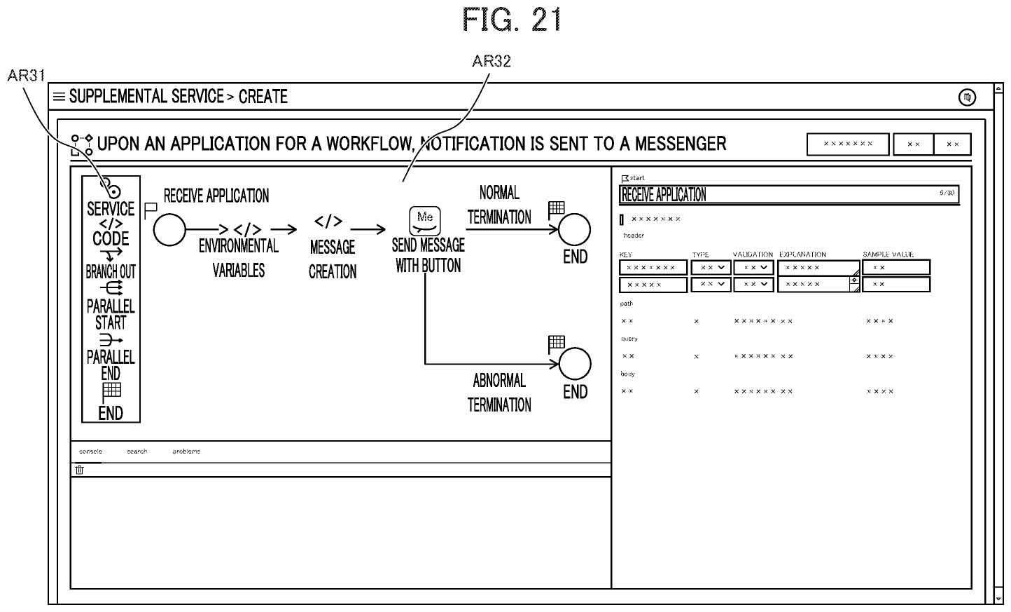

FIG. 20 and FIG. 21 are schematic views showing setting screen examples which are related to supplemental service, and for selecting an API which triggers execution of supplemental service, and selecting a service which is set as a supplemental service. Various services and the like are listed in display area AR21. A bar showing the progress status of setting is displayed in display area AR22. The administrator first selects a normal service or a continuous service, which triggers execution of a supplemental service, from the list in the display area AR21. Next, the administrator selects one of APIs to provide the selected normal service or continuous service from the list in the display area AR21.

The screen then changes to the setting screen example shown in FIG. 21. In this case, as in the display area AR11, icons to select a component included in a supplemental service are displayed in display area AR31. For example, with the icons, a service can be selected, a source code can be selected, and a setting related to branching and parallel processing can be selected. As in the display area AR12, a service or the like selected in the display area AR31 can be arranged in display area AR32 as a component included in a supplemental service. The administrator can easily create a supplemental service flow corresponding to the supplemental service by performing an operation of moving these selected services with a mouse. In this example, a supplemental service flow called “upon an application for a workflow, notification is sent to a messenger” is created.

Thus, upon being triggered by execution of the API that provides the normal service or continuous service selected in FIG. 21, the supplemental service flow created in FIG. 22 is executed.

As described above, thus created continuous service flow and supplemental service flow are converted by the flow conversion unit 112, then set in the database server 20 and can be utilized in the management server 30.

As described above, using the graphical user interface as illustrated, the administrator can easily implement the setting related to a continuous service and a supplemental service only by performing an easy operation such as selection and movement with a mouse.

As mentioned above, the management server 30 according to the present embodiment is configured to, in response to a request from the client terminal 40, return a response to the client terminal 40, and include the continuous service control unit 313, and the supplemental service control unit 315.

The continuous service control unit 313 executes a service corresponding to the request, and returns a result of the execution to the client terminal 40 as a response.

Upon being triggered by execution of the service by the continuous service control unit 313, the supplemental service control unit 315 executes a supplemental service corresponding to the request, and transmits a result of the execution to a transmission destination corresponding to the supplemental service regardless of return of a response.

In this manner, the management server 30 executes a different service for each request. Separately from the service, the management server 30 further executes a supplemental service which is different for each request. In other words, the service and supplemental service to be executed correspond to a combination of the client terminal 40 and the request.

Thus, the management server 30 can provide optimal service and supplemental service for the user of the client terminal 40 based on a pre-set correspondence relationship only. In this case, the client terminal 40 only needs to transmit a request as usual. The service providing server 50 also only needs to return a response according to a request as usual. Thus, it is not necessary to perform work such as modification (e.g., edition of the source code) of existing software that provides services and supplemental services, and a new service providing server 50 does not need to be constructed, thus multiple services can be provided by combining them as the components.

Therefore, the management server 30 enables to solve the problem of providing a variety of services related to information processing more easily.

The continuous service control unit 313 executes multiple services corresponding to a request as a continuous series of services, and returns a response defined for the series of services to the client terminal 40.

Consequently, the management server 30 can provide optimal multiple services as a series of continuous services for the user of the client terminal 40 based on a pre-set correspondence relationship only.

Upon being triggered by execution of a predetermined service in multiple services executed as a continuous series of services, the supplemental service control unit 315 executes a supplemental service corresponding to the request, and outputs a result of the execution regardless of a response.

Thus, a supplemental service can be executed at an appropriate timing according to the progress status of the service.

Upon being triggered by execution of the service by the continuous service control unit 313, the supplemental service control unit 315 determines whether a predetermined condition corresponding to the request is satisfied, and when the predetermined condition is determined not to be satisfied, does not execute a supplemental service.

Thus, only when necessary, a supplemental service along with the service is executed, and when unnecessary, only the service can be executed.

The service and the supplemental service include such a service that is executed by requesting to an external server connected to the management server 30 via an application program interface.

Thus, those services provided by an external server (e.g., an external server managed by the administrator of the management server 30, or an external server managed by a business person different from the administrator) which can coordinate via API can be incorporated in the service and the supplemental service of the management server 30.

As mentioned above, the information processing system S according to the present embodiment is configured to, in response to a request from the client terminal 40, return a response to the client terminal 40, and include the UI control unit 111, the flow conversion unit 112, the setting instruction unit 113, the continuous service control unit 313, and the supplemental service control unit 315.

The UI control unit 111 displays a graphical user interface to select which service and which supplemental service correspond to a request. The flow conversion unit 112 and the setting instruction unit. 113 convert a result of the selection of a user who has referenced the graphical user interface into a computer-executable data format, and set the result of the selection.

The continuous service control unit 313 executes a service corresponding to the request based on the setting of the flow conversion unit 112 and the setting instruction unit 113, and returns a result of the execution to the client terminal 40 as a response.

Upon being triggered by execution of a service by the continuous service control unit 313, the supplemental service control unit 315 executes a supplemental service corresponding to the request based on the setting of the flow conversion unit 112 and the setting instruction unit 113, and transmits a result of the execution to a transmission destination corresponding to the supplemental service regardless of return of a response.

Consequently, the information processing system S can implement a correspondence between request, and service and supplemental service by allowing a user to perform an easy operation using the graphical user interface. In addition, the information processing system S can perform a process similar to that of the management server 30.

Therefore, the information processing system S enables a variety of services related to information processing to be provided more easily.

The flow conversion unit 112 and the setting instruction unit 113 perform setting without modifying the software that provides services and the software that provides supplemental services.

Consequently, in order to set a correspondence relationship, it is not necessary to perform work such as modification (e.g., edition of the source code) of the software that provides services and the software that provides supplemental services.

The present invention is not to be limited to the above-described embodiment. Various changes, modifications, etc. are also covered by the present invention as long as such changes, modifications, etc. fall in a range in which the object of the present invention can be achieved.

For example, the system configuration of the information processing system S in the embodiment described above is exemplary. As long as the functions of the information processing system 1 are implemented as a whole, the multiple servers realized as separate entities may be implemented as a single server, or the functions of the Multiple servers realized as separate entities may be distributed to more servers for implementation.

Services in the embodiment described above may be assumed mainly as services micro services using API-based collaboration, and may include other services like these.

The processing sequence described above can be executed by hardware, and can also be executed by software.

In other words, the functional configuration in the embodiment described above is merely exemplary, and is not particularly limited. That is, any configuration may be employed as long as a function, which enables the series of processes described above to be performed as a whole, is included in any computer included in the information processing system S. What kinds of functional blocks are used to implement this function is not limited to the example described specifically.

A single functional block may be configured by a single piece of hardware, a single installation of software, or a combination thereof.

A recording medium including a program for performing the series of processes described above is configured not only by using a removable medium, which is distributed separately from the apparatus body to provide the program to a user, but also, for example, by using a recording medium provided to a user in a state in which the recording medium is pre-installed in the apparatus body.

As described above, the embodiment of the present invention is described. The present invention is not limited to the embodiment described above. The effects described in the present embodiment are merely a list of the most preferable effects produced from the present invention. The effects of the present invention are not limited to those described in the present embodiment.

### REFERENCE SIGNS LIST

10 administrator terminal, 20 database server, 30 management server, 40 client terminal, 50 service providing server, 800 information processing apparatus, 811 CPU, 812 ROM, 813 RAM, 814 bus, 815 input unit, 816 output unit, 817 storage unit, 818 communication unit, 819 drive, 820 image capture unit, 831 removable medium, 111, 411 UI control unit, 112 flow conversion unit, 113 setting instruction unit, 121 service information storage unit, 211 database management unit, 221 continuous service database, 222 supplemental service database, 311,511 request response transmitter and receiver, 312 service identification unit, 313 continuous service control unit, 314 flow execution unit, 315 supplemental service control unit, 321 processing data storage unit, 412 request unit, 413 client-side processing unit, 421 client-side software storage unit, 512 server-side processing unit, 521 server-side software storage unit, S information processing system

1. An information processing device that, in response to a request made by each of a plurality of users using a client terminal, returns a response to the client terminal as a request source, the information processing device comprising:
an identification unit configured to identify, based on user identification information included in the request, whether a supplemental service corresponding to the user using the client terminal as the request source is present;
a first process control unit configured to execute a service corresponding to the request, and return a result of the execution as the response to the client terminal as the request source; and
a second process control unit configured to, when the supplemental service is identified to be present by the identification unit, upon being triggered by execution of the service by the first process control unit, execute the supplemental service, and return a result of the execution to a transmission destination corresponding to the supplemental service regardless of return of the response.

2. The information processing device according to claim 1, wherein even when the service corresponding to the request is the same, whether the supplemental service is present, and a process content of the supplemental service when the supplemental service is present are different for each of the plurality of users.

3. The information processing device according to claim 1, wherein the first process control unit executes a plurality of services corresponding to the request as a continuous series of services, and identifies which services in the plurality of services included in the series of services provide execution results to be included in the response based on a definition corresponding to the series of services, and returns only the execution results of the identified services to the client terminal as the response.

4. The information processing device according to claim 1, wherein:
an association is set between the supplemental service corresponding to the user using the client terminal as the request source, and the user identification information based on setting instructions of another user other than the plurality of users who make a request using the client terminal, and
the identification unit identifies whether a supplemental service corresponding to the user using the client terminal as the request source is present based on setting content in the setting, and the user identification information included in the request.

5. The information processing device according to claim 1, wherein when the supplemental service is identified to be present by the identification unit, upon being triggered by execution of the service by the first process control unit, the second process control unit determines whether a predetermined condition corresponding to the user using the client terminal as the request source is satisfied, and when the predetermined condition is determined not to be satisfied, does not execute the supplemental service.

6. An information processing system that, in response to a request made by each of a plurality of users using a client terminal, returns a response to the client terminal as a request source, the information processing system comprising:
a display control unit configured to display a graphical user interface including an icon indicating a service and an icon indicating a supplemental service;
a setting unit configured to set an association between a supplemental service corresponding to the user using the client terminal as the request source, and user identification information based on setting instructions accompanied by selection of the icon indicating the service and selection of the icon indicating the supplemental service by a user who has referenced the graphical user interface;
an identification unit configured to identify, based on setting content in the setting and the user identification information included in the request, whether a supplemental service corresponding to the user using the client terminal as the request source is present;
a first process control unit configured to execute a service corresponding to the request, and return a result of the execution as the response to the client terminal as the request source; and
a second process control unit configured to, when the supplemental service is identified to be present by the identification unit, upon being triggered by execution of the service by the first process control unit, execute the supplemental service, and return a result of the execution to a transmission destination corresponding to the supplemental service regardless of return of the response.

7. The information processing system according to claim 6, wherein the setting unit performs the setting without modifying software that provides the service and software that provides the supplemental service.

8. An information processing method performed by an information processing device that, in response to a request made by each of a plurality of users using a client terminal, returns a response to the client terminal as a request source, the information processing method comprising:
an identification process comprising identifying, based on user identification information included in the request, whether a supplemental service corresponding to the user using the client terminal as the request source is present;
a first process control process comprising executing a service corresponding to the request, and returning a result of the execution as the response to the client terminal as the request source; and
a second process control process comprising, when the supplemental service is identified to be present by the identification process, upon being triggered by execution of the service by the first process control process, executing the supplemental service, and returning a result of the execution to a transmission destination corresponding to the supplemental service regardless of return of the response.

9. An information processing method performed by an information processing system that, in response to a request made by each of a plurality of users using a client terminal, returns a response to the client terminal as a request source, the information processing method comprising:
a display control process comprising displaying a graphical user interface including an icon indicating a service and an icon indicating a supplemental service;
a setting process comprising setting an association between a supplemental service corresponding to the user using the client terminal as the request source, and user identification information based on setting instructions accompanied by selection of the icon indicating the service and selection of the icon indicating the supplemental service by a user who has referenced the graphical user interface;
an identification process comprising identifying, based on setting content in the setting and user identification information included in the request, whether a supplemental service corresponding to the user using the client terminal as the request source is present;
a first process control process comprising executing a service corresponding to the request, and returning a result of the execution as the response to the client terminal as the request source; and
a second process control process comprising, when the supplemental service is identified to be present by the identification process, upon being triggered by execution of the service by the first process control process, executing the supplemental service, and returning a result of the execution to a transmission destination corresponding to the supplemental service regardless of return of the response.

10. A non-transitory storage medium encoded with a computer-readable program that controls a processor of a computer being configured to, in response to a request made by each of a plurality of users using a client terminal, return a response to the client terminal as a request source, to execute processing comprising:
an identification processing configured to identify, based on user identification information included in the request, whether a supplemental service corresponding to the user using the client terminal as the request source is present;
a first process control processing configured to execute a service corresponding to the request, and return a result of the execution as the response to the client terminal as the request source; and
a second process control processing configured to, when the supplemental service is identified to be present by the identification processing, upon being triggered by execution of the service by the first process control processing, execute the supplemental service, and return a result of the execution to a transmission destination corresponding to the supplemental service regardless of return of the response.
